(19) United States
(12) Patent Application Publication
(10) Pub. No.: US 2010/0068495 A1
(43) Pub. Date: Mar. 18, 2010

(54) SINGLE LAY STEEL CORD FOR ELASTOMER REINFORCEMENT

(75) Inventors: Hendrik Rommel, Varsenare (BE); Bert Vanderbeken, Waregem (BE)

Correspondence Address: FOLEY AND LARDNER LLP;SUITE 500, 3000 K STREET NW, WASHINGTON, DC, 20007, US

(73) Assignee: NV BEKAERT SA

(21) Appl. No.: 12/516,637

(22) PCT Filed: Nov. 30, 2007
(86) PCT No.: PCT/EP07/63038

§ 371 Date: May 28, 2009

(30) Foreign Application Priority Data
Dec. 29, 2006 (EP) 06077340.5

(51) Int. Cl. B32B 27/40; D07B 1/06; D07B 7/02

(52) U.S. Cl. 428/222; 57/213; 57/14

(57) ABSTRACT

A steel cord (200) is described that is simple and cost effective to produce while solving some particular problems for the reinforcement of elastomer belts such as timing belts or the like. The cord (200) is a single lay cord that comprises a core filament (202), around which a first layer and a second layer of filaments (204, 210, 212) is twisted, all filaments being twisted with the same lay length and direction. By appropriate choice of the lay length, the core filament diameter and the filament diameters of the first layer—the latter being larger or equal to the former—an aggregate gap can form in which intermittently a filament (210′) of the second layer gets entrained. This aggregate gap must be between 40 and 70% of the core filament diameter in order to obtain the desired effect of having a core filament (202) that is deformed with the same lay length and direction as the other filaments (204,210,212). A deformed core filament (202) suppresses the effect of core filament migration. In addition the exceptional rough aspect of the cord (200) leads to good mechanical anchorage in the elastomer. Also the load exerted on the cord (200) is better distributed over all filaments. The use of the cord is not limited to timing belts: an advantageous use of the cord in tyres, hoses, hoisting belts, drive belts and reinforcing strips is anticipated.

### FIELD OF THE INVENTION

The invention relates to a simple to make yet effective steel cord that is particularly suited to reinforce applications wherein the reinforcement is subject to repeated pull-pull cycles while being embedded in an elastomer.

### BACKGROUND OF THE INVENTION

Nowadays, synchronous belts—also known in the art as ‘toothed belts’ or ‘transmission belts’ or ‘timing belts’—are not longer exclusively found in machines where they are particularly liked for their precise and high-power transfer of motion, but also in day-to-day appliances such as garage door openers or sliding doors. There they are favoured over the traditional cable or chain system for their operational silence. While in these systems the belt is relatively moderately loaded in terms of force and speed, other issues come of importance such as the price of the whole system and the durability.

While—at least for the synchronous belts that are reinforced with steel cords—typically stranded cords where used in the past, these cords have definitely a drawback in terms of cost (a ‘cost problem’). Indeed a stranded cord is assembled out of strands that on their turn first have to be assembled out of steel filaments. It follows that at least a double operation is required. Such stranded cords are typically of the type 3×3, 7×3, 3+5×7, . . . the latter formula for example denoting a core strand consisting of 3 filaments that are twisted together and surrounded by 5 strands each consisting of a single core wire around which 6 outer wires are twisted. This type of built-up is typical for the very first steel cords that were used for the reinforcement of radial tyres at the end of the thirties and remained in use well into the sixties of last century for that purpose. They found a second product life in the reinforcement of belts and in particular synchronous belts. Especially polyurethane belts are predominantly reinforced with such steel cords. They are liked there for their mechanical anchorage into the elastomer matrix. Indeed, e.g. a 3×3 steel cord has a very rough outer circumferential surface in which the polyurethane leaks into during extrusion of the belt. After cooling the solidified polyurethane anchors the cord into the belt. Moreover, due to the twist of the filaments in the strand and the strands in the cord, each and every filament is on turn in contact with the polyurethane. As a result the forces exerted on the teeth of the belt are transmitted through the polyurethane to all the filaments in the cord. Therefore all filaments take up approximately the same amount of force.

However, the stranded cords do have some drawbacks. Apart from their higher manufacturing costs, they also have the tendency to have a somewhat higher initial elongation. Indeed, the strands act as helical springs in the cord leading to an initial lower force take-up (giving rise to a ‘dimensional problem’) as it leads to synchronous belts of which the teeth-to-teeth distance is difficult to control. A solution to this has been described in WO 2005/043003 but this solution does not resolve the cost issue. As for the steel cord for the reinforcement of tyres cost pressure has lead to the introduction of layered constructions as a first step and compact cord constructions as an even further step in cost reduction, the same solutions have been tried for synchronous belts as well (see e.g. U.S. Pat. No. 4,158,946). For clarification: layered constructions are constructions that start from a core—that can either be a filament or a strand simple strand e.g. a 3×1 or 4×1—around which a layer of filaments is twisted with a lay length or direction that differs from the lay-length or direction of the core. A typical example is 3+9 indicating that a 3×1 core strand is surrounded by 9 filaments with a different lay length or lay direction. The layering process can be repeated leading to such constructions like 1+6+12 or 3+9+15, the latter still being a very popular steel cord for tyre reinforcement. Although the making of such layered cords still involves more than one step, the use of filaments allows for much longer runtimes of the machines than is possible with strands (that are generally thicker hence less length can be put on a machine spool).

The ultimate saving in cost can be achieved by spinning all filaments of the cord together in one single processing step by giving them all the same lay-length and direction. Such a cord is called a ‘single lay’ cord. In this way one arrives at constructions like 19 compact cord or 27 compact cord (the earliest disclosure of such steel cords probably being JP-A-51-058555) that respectively consist of 19 or 27 identical steel filaments that are all twisted together with the same lay. The filaments arrange themselves in a ‘compact’ hexagonal arrangement, hence the naming of the construction. While these ‘compact constructions’ have a number of advantages over and above their favourable production cost such as the optimal use of filament strength because of the line contacts that exist between filaments (as opposed to the point contacts that exist in layered constructions where filaments cross one another) and the improved fatigue life that follows there from they also suffer from a ‘core migration problem’. The core migration problem occurs when the cord—that is embedded in an elastomer—is cyclically bent. As the central filaments are only held by the surrounding layer of steel filaments—with relatively low friction between the filaments—they tend to be moved out of the steel cord.

Again a number of solutions to solve the ‘core migration’ have been proposed such as e.g. introducing relative position changes of the filaments in the cord as suggested in U.S. Pat. No. 4,724,663. Still another solution that was suggested was to introduce randomness in the cord by mingling the filaments through one another as in proposed in U.S. Pat. No. 4,828,001. Still another solution is to introduce thicker filaments in the core that are surrounded by thinner filaments in the outer layers one popular example being 3|9 (wherein the stroke ‘|’ separates the inner core filaments from the outer layer filaments, see e.g. EP 0194011). The thicker core filaments open the outer layer so that rubber can reach the core and thereby fix the core filaments by means of the adhesion that occurs between the rubber and the adherent coating of the core filaments. Although these solutions—and in particular the latter solution—turned out to be very successful in the field of tyre reinforcement, they turned to be worthless when used in synchronous belts, particularly when the elastomer is a thermoplastic material such as polyurethane.

This is due to a number of causes:
A. The reinforcement of a belt is subjected to repeated pull-pull cycles, the highest tensile force being exerted in the part of the belt that moves towards the drive pulley—the ‘forward path’—the lower force being exerted in the part of the belt that moves away from the drive pulley (the return path). When the belt is slack in the return path, the cords can even go into compression which is very bad for the functioning of the system. The repetitive pull-pull cycles induce a ‘peristaltic’ action on the core of the layered or compact cord leading to a core that slowly but surely exits the belt. The problem of ‘core migration’ is therefore even more outspoken for belt reinforcement than in tyre reinforcement.
B. Only the outer filaments can contact the elastomer. Hence, the forces exerted by the pulley on the teeth are transmitted to the reinforcement over the outer filaments only. As there is no or very little friction between the steel filaments of the core versus the outer layer, only the outer filaments are fully loaded—even overloaded—while the core filaments are underused. In order to solve this, one tends to overdimension the reinforcement partially annihilating the cost advantage one obtained by introducing the layered or compact cord structure. The solution suggested in EP 0194011 (cited before) does not help here because as the pressures involved in the manufacturing of polyurethane belts is lower than during e.g. vulcanisation of rubber, the PU cannot penetrate down to the core and there is no ‘glueing’ of the core to the outer filaments due to a lack of chemical adhesion.
C. The outer surface of the layered constructions is very smooth: many fine filaments are closely arranged to one another thereby reducing the possibility for mechanical anchorage of the steel cord in the elastomer. Although compact cords have a regular polygonal outer shape that is screw-like with the pitch of the lay, this screw-like surface does not suffice to enable even a moderate mechanical anchoring. Also the ‘mingling’ of the filaments as suggested in U.S. Pat. No. 4,828,001 will not result in an improvement there, because the repositioning of the filaments only occurs over many laylengths giving locally no anchorage.
   Cause ‘A’ can lead to the problem that freed core filaments get trapped on pulley axles leading to a complete mess in the belt transmission system. The problem is even aggravated when the core is a single filament (such as a 1+3N type of construction) as the straight core filament resists compression as it is held by the surrounding layer.

In applications where a length of toothed belt is held at the end by means of an engagement clamp—like in a (garage) door opener—that holds three to ten of the last teeth (without squeezing the belt) cause B can lead to unexpected belt breakage at the clamp whereby the outer filaments break while the core filaments are not broken what is called the ‘sequential breakage problem’. Or—even worse—due to cause C the steel cord as a whole is torn out of the elastomer due to the lack of ‘mechanical anchoring’ on the smooth surface.

To summarise, there are indeed some issues that have to be overcome in order to progress the use of steel cord in synchronous belts reinforcement such as:

1. The cost problem
2. The dimensional problem
3. The core migration problem
4. The sequential breakage problem
5. The mechanical anchorage problem.

### SUMMARY OF THE INVENTION

The object of the invention was therefore to find a cord out of a class of cords that at least solves some of the above 5 problems individually. Preferably a cord had to be found that at least solved the core migration, sequential breakage and anchorage problem. Another object of the invention is to resolve all problems with a single cord.

Ultimately, the inventors found a cord that could resolve the problems associated with the prior art. Moreover, the ideas underlying this cord can be fruitfully extended to a whole class of constructions of which the features are defined in the main claim 1. Beneficial embodiments are described in the claims depending thereon.

From the beginning it was felt that only a single lay cord could resolve the cost problem as this is the only cord wherein only one assembly step is present. A single lay cord is also a cord with a high modulus and low initial elongation. However, the solutions provided by the prior-art for tyre reinforcement—as touched upon in the previous section—are not useful when applying them to polyurethane belts as the core migration problem is more outspoken in this application, low pressures are being used in fabrication and there is a lack of chemical adhesion with the polyurethane.

As a starting point a single lay cord with a core filament having a core filament diameter ‘d₀’ was chosen. Around this core a first layer of filaments are disposed. The diameters of these first layer filaments can be different or equal to one another but in any case each one of them is larger or equal than the core filament diameter. Around this first layer, a second layer of filaments are disposed. Again the diameters of these second layer filaments can be different from one another, but each of them is equal or larger than the core filament diameter. The filaments are twisted around one another in one single operation with one single lay length and direction. In the process, the steel filaments of the first and second layer filaments are plastically deformed, and when they are unravelled out of the cord they still show the lay length and direction in which they were twisted together.

Such a type of cord is known and the special case of having a single core surrounded by five equal first layer filaments is described in EP 1474566. In these type of cords, the gaps between the first layer filaments is customary kept small but not too small, such that the filaments do not touch one another upon twisting and to keep the core filament fixed. This is normally done by choosing the core filament diameter somewhat larger than would be required to tangentially touch the regularly arranged first layer filaments. Such an arrangement is relatively stable and the filaments cannot reposition themselves during production and use.

By now further exploring arrangements wherein the core is much larger than what is considered acceptable in the art, the inventors found some surprising effects. Specific values of the lay length, the core filament diameter and the first layer filament diameter result in one unfilled segment in the first layer when all first layer filaments are aggregated together. The unfilled segment forms a gap having a certain width in which a filament of the second layer can get restrained. The definition of ‘aggregate gap’ is best understood by considering FIG. 1 that represents a cross section of a cord construction with a lay length that is very large in terms of d₀ (say 50 times d₀). The aggregate gap ‘δ’ is the ‘gate’ through which a circular filament of a size larger than δ can not pass, while a filament with a smaller diameter than δ could pass (taking abstraction of the possible hindrance of the core filament). When the first layer of filaments consists of equal filaments having a first diameter d₁ some high-school geometry learns that the gap ‘δ’ is, to a first approximation, equal to:

$$δ = \frac{( {d}_{0} + {d}_{1} ) sin ( [ n - 1 ) α ] - {d}_{1}}{\sqrt{1 + {[ \frac{π ( {d}_{0} + {d}_{1} )}{L} ]}^{2}}}$$

$$Wherein$$

$$sin ( α ) = \frac{{d}_{1}}{{d}_{0} + {d}_{1}} and n = int ( π / α )$$

‘n’ is the number of first layer filaments that fits into the layer without hindering one another, ‘L’ is the single lay length given to all filaments. This approximation nears exactness for increasing lay lengths and is for the usual lay lengths and diameters of satisfactory precision. When the first layer consists of filaments having a mutually differing diameter (but each one bigger or equal than d₀) the formula gets more complex but the inventive ideas explained below remain applicable. Hence, the formula should not be regarded as delimitative to the invention, but as a vehicle to explain the underlying ideas

When the diameters of the first layer filaments are properly chosen, a filament of the second layer can get trapped in this aggregate gap. A gap with a width of between 40 to 60% of the first filament diameter ‘d₁’ just suffices to entrain the caught second layer filament. Such a configuration is inherently unstable as the trapped filament will try to get into the first layer. Consequently, another filament out of the first layer will be compelled to move out thereby exchanging a filament of the first layer with a filament of the second layer. This process repeats itself approximately every lay length. So the entrainment of the filament is intermittent and different filaments of the second layer can nest on turn in the first layer. One therefore should not look upon this aggregate gap as a static given but a segment formed between variable pairs of adjacent first layer filaments that continuously angularly shift along the length of the cord. As all these rearrangements take place during the forming of the cord, such an arrangement turned out to lead to a core filament that is not longer straight, but shows a deformation with the same lay length and direction as the other filaments. This deformation is substantially helical with a varying radius along the axis of the cord. The helically deformed core filament helps to prevent core migration and is not found in the prior-art type of cords of this make. Other preferential ranges for the gap are between 47% and 70% of d₀, or between 40% and 64% of d₀ or even between 47% to 64% of d₀. Smaller gaps as well as larger gaps lead to stable configurations, and stable configurations lead to a straight i.e. a not deformed core filament.

The filaments themselves are substantially round steel filaments with a diameter of between 0.02 to 0.30 mm, more preferred between 0.04 and 0.175 mm. Plain carbon steel is preferably used. Such a steel generally comprises a minimum carbon content of 0.40 wt % C or at least 0.70 wt % C but most preferably at least 0.80 wt % C with a maximum of 1.1 wt % C, a manganese content ranging from 0.10 to 0.90 wt % Mn, the sulfur and phosphorous contents are each preferably kept below 0.03 wt %; additional micro-alloying elements such as chromium (up to 0.2 to 0.4 wt %), boron, cobalt, nickel, vanadium—a non-exhaustive enumeration—may also be added. Such carbon steel filaments can now be produced at strengths in excess of 2000 MPa, preferably above 2700 MPa, while now strengths above 3000 MPa are becoming current and inroads are being made for strengths over 4000 MPa. Also preferred are stainless steels. Stainless steels contain a minimum of 12 wt % Cr and a substantial amount of nickel. More preferred are austenitic stainless steels, which lend themselves more to cold forming. The most preferred compositions are known in the art as AISI (American Iron and Steel Institute) 302, AISI 301, AISI 304 and AISI 316 or duplex stainless steels known under EN 1.4462.

Alternatively, the filament that fills the aggregate gap will occupy a position roughly midway between said first and second layer. An estimate for the distance between the core filament, and the filament of the second layer is given in table 1 below for the simplified case of having all filaments in the first layer equal.

Due to this ‘collapsed’ second filament layer, a groove occurs at the outer surface of the cord. Such a groove is particularly advantageous because it helps to lock the cord in the elastomer. Moreover, as this groove changes angular position over the length of the steel cord, the outer surface of the cord is particularly rough and irregular what helps to anchor the cord into the polyurethane. Further elaborating on this observation, the inventors reduced the number of filaments from the maximum possible ‘saturated’ level yielding an ‘unsaturated’ layer. A saturated second layer is for the purpose of this application understood to be a second layer comprising twice the number of filaments that make up the first layer. With this ‘unsatured layer’ further deep grooves become available for the elastomer to flow into and give a better anchoring. Also the presence of the aggregate gap gives rise to second layer filaments wandering within their layer further contributing to the longitudinal irregularity of the cord. This all yields a better distribution of forces when the cord is embedded in elastomer as more filaments come into contact with it. The number of filaments in the second layer can ultimately be reduced to one. Another advantageous number of filaments is the number of filaments in the first layer, or twice the number of first layer filaments. Filaments in the second layer must have a diameter of at least the core filament diameter as otherwise they could enter the gapand give rise to a stable configuration. Preferred configurations are when the second layer comprises filaments with a core filament diameter and with a first filament diameter, or where the second layer only comprises filaments with a first filament diameter.

The most preferred configurations are when a core filament is surrounded by three, four, or five first layer filaments. The requirement of having an aggregate gap of between 0.40×d₀ and 0.70×d₀ then translates into ratios of d₁/d₀.

| Gap δ | |
|---|---|
| Gap of 40% | |
| of d₀ to . . . | 70% of d₀ |

| n | d₁/d₀ | Δ/d₀ | d₁/d₀ | Δ/d₀ |
|---|---|---|---|---|
| 4 | 2.045 | 0.245 | 1.705 | 0.163 |
| 5 | 1.217 | 0.378 | 1.024 | 0.068 |

This is for an infinite length of lay. Introducing a lay length will decrease the gap between filaments of the first layer.

In order to make the filaments of better use in an elastomer the filaments are coated, with an organic or inorganic—such as a metallic—coating. Such a coating may be useful to protect the steel cord better against corrosion, or to enable chemical adhesion with the elastomer on top of the mechanical anchoring. Suitable coatings known in the art are:
Corrosion resistant coatings are e.g. zinc or a zinc aluminum alloy. Most preferred is a low zinc, hot dip coating as described in EP 1280958. Such zinc coating has a thickness lower than two micrometer, preferably lower than one micrometer, e.g. 0.5 μm. An alloy layer zinc—steel is present between the zinc coating and the steel.
Metallic adhesion coatings are brass coatings when rubber is used as an elastomer. So called ‘ternary brass’ such as copper-zinc-nickel (e.g. 64% by weight/35.5 wt. %/0.5 wt. %) and copper-zinc-cobalt (e.g. 64 wt. %/35.7 wt. %/0.3 wt. %), or a copper free adhesion system such as zinc-nickel or zinc-cobalt.
Organic adhesion coatings are by preference coatings based on organofunctional silanes, organofunctional titanates or organofuctional zirconates such as described in WO-A-99/20682 (NV Bekaert SA).

According a second aspect of the invention, a process to manufacture the cord is claimed. Said method is the standard method used for the production of single lay cords as known in the art but has been adapted with certain inventive features. A number of spools on length are provided with the steel filaments of the respective diameters on them. The filament diameters are chosen as per the description above. The filaments are twisted together with the same lay direction and length by a rotary assembly machine. Such an assembly machine is a cabling machine or a bunching machine that obviously has a well defined axis of rotation. The first layer filaments are deposited around the core filament in a first cabling point thus forming an intermediate strand. In a second cabling point, the filaments of the second layer are added to this intermediate strand. Different with the prior art is now that the core filament enters the first cabling point under an angle, so that the plane formed by the core filament entering the first cabling point and the rotation axis remains stationary with respect to the assembly machine. The angle between rotation axis and core filament is preferably between 1 to 10°, more preferably between 2° and 5°. This out-of-line arrangement slightly pulls the core filament out of center thereby leading to a one-sided arrangement of the first layer filaments that on their own turn induce an aggregate gap.

The uneven distribution of first layer filaments can also be improved by feeding the first layer filaments one-sidedly. With one-sidedly is meant e.g. in the case of five filaments being fed at the first cabling point, the filament are not fed even angularly under angles of 72° but under angles of e.g. 60° (obviously leading to one large gap of) 120°.

The filaments have to be held taut upon entering the machine with a certain tension. When now the tension of the core filament is kept below that of the first layer filaments, the core filament intermittently exchanges position with a filament of the first layer.

According a third aspect of the invention the elastomer products reinforced with the inventive steel cord are claimed. Although the inventive steel cord was primarily developed for the reinforcement of belts for use in garage door openers, it is equally well useable in all kinds of timing belts or synchronous belts as they are also called in the art. Also hoisting belts for use in elevators can be reinforced with the inventive steel cord thereby providing a good cost-effective alternative for the existing type of reinforcement. The use of the cord to reinforce conveyor belts as e.g. in the food processing industry is also envisaged. Also for the reinforcement of high pressure hoses it can be used. Although the use of the cord in tyres has not been tested yet, it could equally well be considered an alternative to the existing layered cords or compact cords.

### BRIEF DESCRIPTION OF THE DRAWINGS

The invention will now be described into more detail with reference to the accompanying drawings wherein

FIG. 1 shows the geometry involved for defining the distinctive structural feature of the cord.

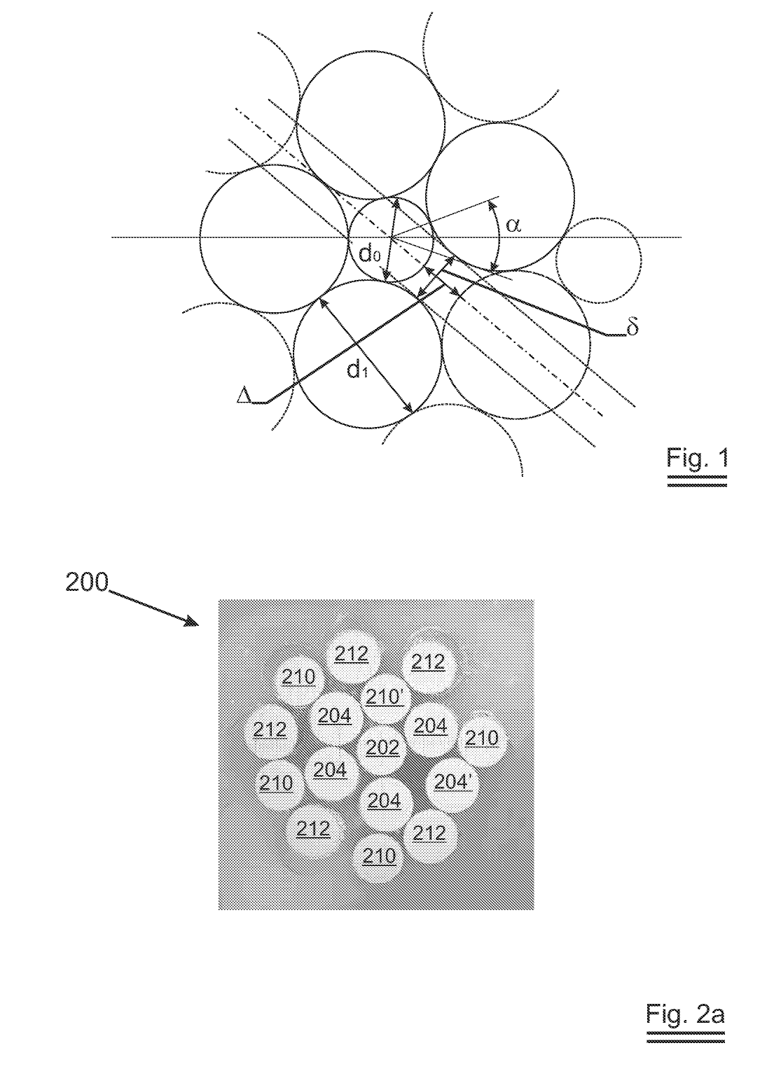

FIG. 2 ‘a’, ‘b’, ‘c’ show different cross sections of a first embodiment of the inventive cord.

FIG. 3 ‘a’, ‘b’ show different cross sections of a second embodiment of the inventive cord.

FIG. 4 ‘a’ shows a cross section of a third embodiment of the inventive cord, ‘b’ shows a trace of the individual filaments over half of the lay length of the cord.

### DESCRIPTION OF THE PREFERRED EMBODIMENTS OF THE INVENTION

The original proposal for providing a low cost alternative was to use a 1|3×N type of construction such as d₀+(5×d₁|5×d₂|5×d₃) as described in EP 1474566 wherein the core filament diameter d₀ is sufficiently small enough in order to fit in the centre of the first layer of 5 filaments with diameter d₁. Filaments with diameters d₂ and d₃ form the second layer surrounding the first layer. The filaments between brackets are assembled together in one operation with one lay. The stroke ‘|’ separates filaments that can be found on different circles with respect to the centre when ‘regularly arranged’. With ‘regularly’ arranged is meant that the centres of the first layer filaments are on a regular N-gon, N being the number of filaments in that layer. The filaments of the second layer fit themselves adjacent to two filaments of the first layer in the crevice formed by those filaments, and according the circumferential arrangement in which they are fed (e.g. alternatingly ‘d₂’ and ‘d₃’). Such a regular arrangement is prone to core migration even if the centre filament is slightly enlarged as described in EP 1474566.

By now further increasing the core filament diameter relative to the first layer filament diameters beyond the boundaries the person skilled in the art would normally consider reasonable, something interesting occurred. As the gaps between the first layer filaments then become very large, one of the filaments of the second layer will wick in between two filaments of the first layer, thereby enlarging the gap formed and pushing the other filaments of the first layer together. This intruding second layer filament will however not completely be able to enter the first layer as not enough space is provided. Hence this filament temporarily positions itself between the first and second layer. As a result an unstable configuration forms wherein the relative positions of first and second layer filaments keep changing during cord formation. Surprisingly enough, this does not leave the core filament unaffected and when unravelling the cord, it was found that the core filament showed a substantially helical deformation with the same lay length and direction—albeit with a variable radius—as the other filaments, a feature not found back when a ‘stable configuration’ was made. Another prominent feature was that the cord has a particularly rough outer aspect and does not resemble in any way the nicely polygonal cross section and screw of the regular version of EP 1474566.

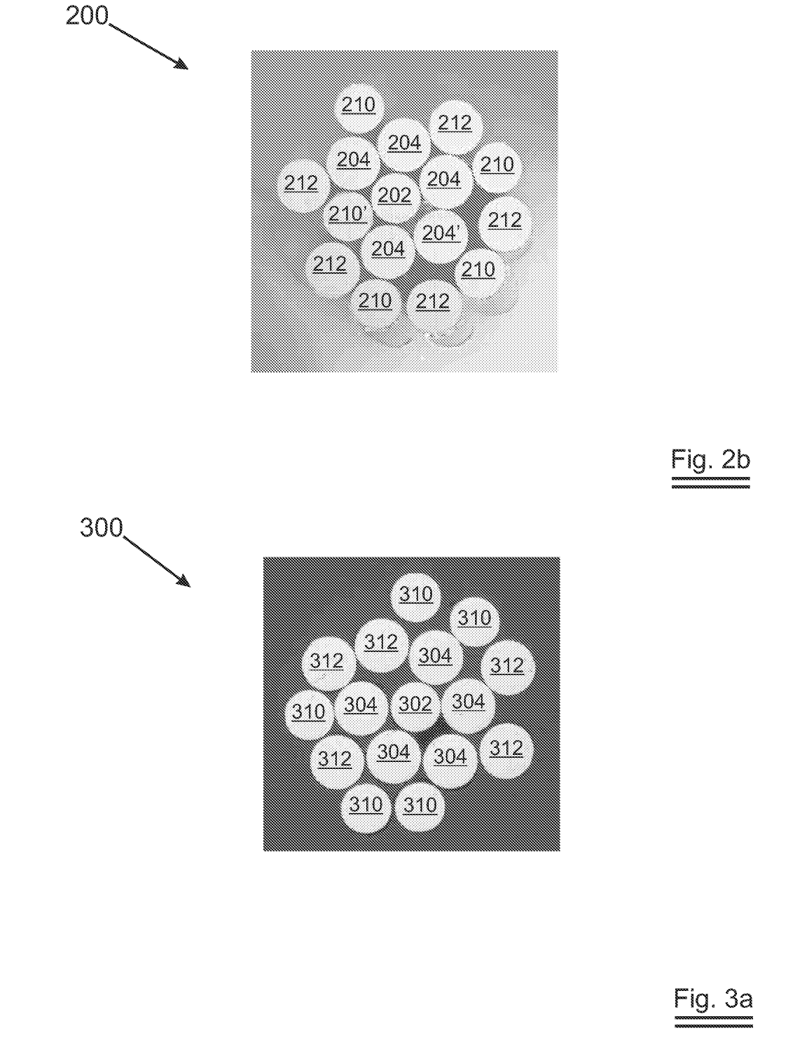

In a first embodiment—depicted in FIG. 2—a cord 200 with the following geometry was produced:

0.12+(5×0.13;5×0.13;5×0.12)8 mm S

i.e. a core filament 202 of 0.12 mm that is in a first layer surrounded by 5 filaments of 0.13 mm 204 which on its turn is surrounded by a second layer of 10 filaments alternatingly with a 0.13 mm 212 and a 0.12 mm 210 filament. Another notation has been chosen as it turns out that certain filaments cannot longer be identified as being on a circle relative to the core. FIG. 2 ‘a’ and ‘b’ are cross sections from such a cord taken at different places along the cord.

The d₁/d₀ ratio is 1.08. The filaments of core and first layer are chosen such that an aggregate gap of 55.8% of 0.13 mm forms when 5 filaments surround the core at a lay of 8 mm. This gap is large enough to trap one of the filaments of the second layer, but not large enough to accommodate 6 filaments in the first layer. Even when a second layer filament—such as 210′—enters the first layer, there is not enough space and a 204′ filament is expelled out of the first layer. As one of the filaments out of the second layer is at least partly entering the first layer, the second layer becomes unsaturated and—as the cross-sections reveal—the cord gets a generally rough outer aspect. Upon unravelling, the core filament showed a substantially helical deformation with the same lay length of 8 mm in S direction but with a variable radius.

Some further details: the cord was made of zinc coated filaments, the diameter was 0.603 mm with a fairly high difference between maximum and minimum diameter of 0.007 mm (measured with a standard micrometer having 12 mm diameter circular anvils), the mass per meter was 1.58 gram/m and a breaking strength of 529 N with a very low structural elongation of 0.012% was found.

The advantages of the inventive cord became particularly prominent when performing a tensile test in polyurethane: either end of an about 12 cm sample of cord is embedded—by casting hot PU into a mold holding the sample—in a block of 5 cm long, by 2 cm wide and 1 cm high. After cooling, the two PU blocks are pulled apart and the fracture behaviour is observed. As a reference a 1+6+12×0.120 mm type of cord was used (layered structure). The reference cord has a breaking force of 620 N in a normal tensile test (no embedment). The following was observed (two embedded tests were made):

| | Standard | Embedded | Filaments |
|---|---|---|---|
| Steel cord | test | test | not broken |
| 1 + 6 + 12 × 0.120 Ref. | 620 N | 511\|514 N | 7 i.e. the core |
| 0.12 + (5 × 0.13; 5 × 0.13; | 529 N | 534\|541 N | 3\|1 |
| 5 × 0.12) | | | |

The reference cord clearly shows a less efficient strength behaviour as the tensile forces are transmitted to the cord only via the outer sheath of the cord and—as the core is not in touch with the PU—the core largely remains unloaded. The inventive cord clearly shows a better use of the strength, although its breaking load in the normal test is much lower. This is attributed to the better anchorage of the core filament and first layer in the second layer and the unsaturated second layer giving a better contact surface with the PU. Note the increase in breaking load between the standard test and the embedded test that can probably attributed to an increased hardening due to the heat applied during preparation of the sample. The inventive cord thus solves the sequential breaking problem.

In a second embodiment, the above results were confirmed on another geometry:

0.17+(5×0.185;5×0.185;5×0.17)12 mm S

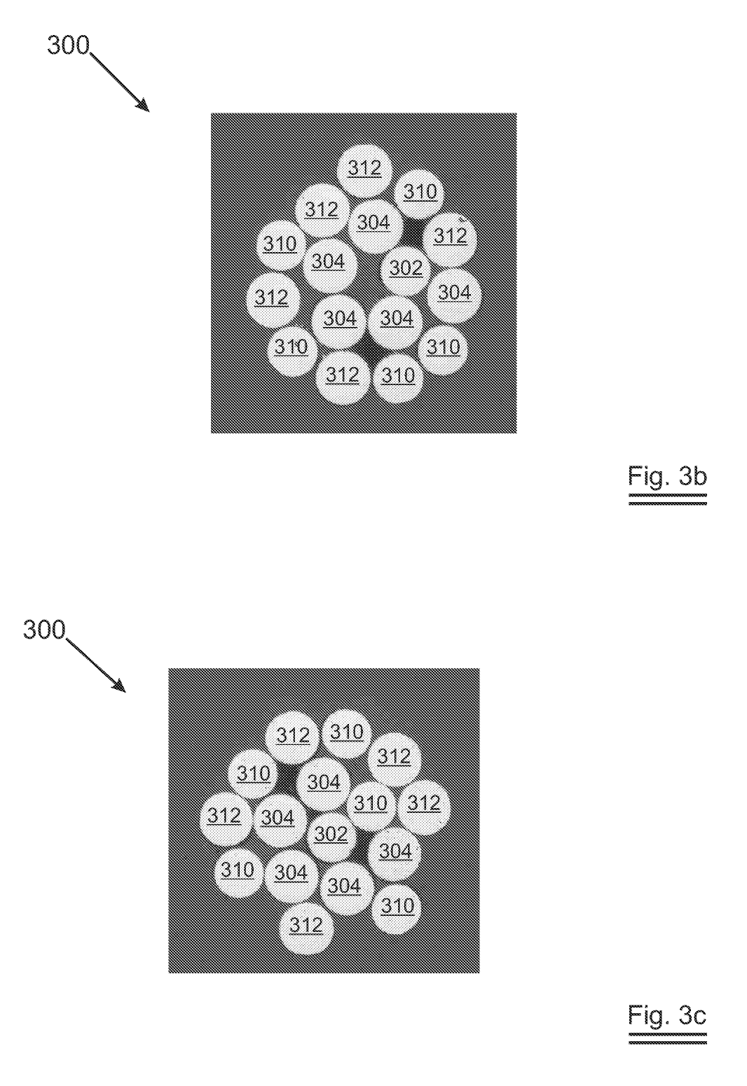

The aggregate gap for the first layer can be calculated to be 55.0% of 0.185 mm. The d₁/d₀ ratio is 1.09. FIG. 3 ‘a’, ‘b’ and ‘c’ show different cross sections 300 along the cord, several millimetres apart. The core filament 302 can be discerned. While originally the filaments of the second layer were fed into the second cabling point in an alternating manner when circulating around the core i.e. 310 [symbol] 312 [symbol] 310 [symbol] 312 [symbol] 310 [symbol] 312 [symbol] 310 [symbol] 312 [symbol] 310 [symbol] 312 this order can change completely because a filament of the outer layer can jump over a ‘submerged’ other filament of the outer layer resulting in the sequence of e.g. FIG. 2a: 310 [symbol] 310 [symbol] 312 [symbol] 312 [symbol] 310 [symbol] 310 [symbol] 312 [symbol] 310 [symbol] 312 [symbol] 312.

This cord had the following properties: a linear mass of 3.179 g/m, a breaking load of 1107 N, an effective tensile strength of 2737 MPa, a large modulus of 194 760 MPa compared to strand cords of type 7×3 or 3×3 that have a modulus of 180 000 MPa. A large modulus is specifically beneficial if only little elongation is allowed in the reinforcement application.

Finally an embodiment with a largely unsaturated second layer has been produced with the following geometry:

0.175+(5×0.20;3×0.20)12 mm S

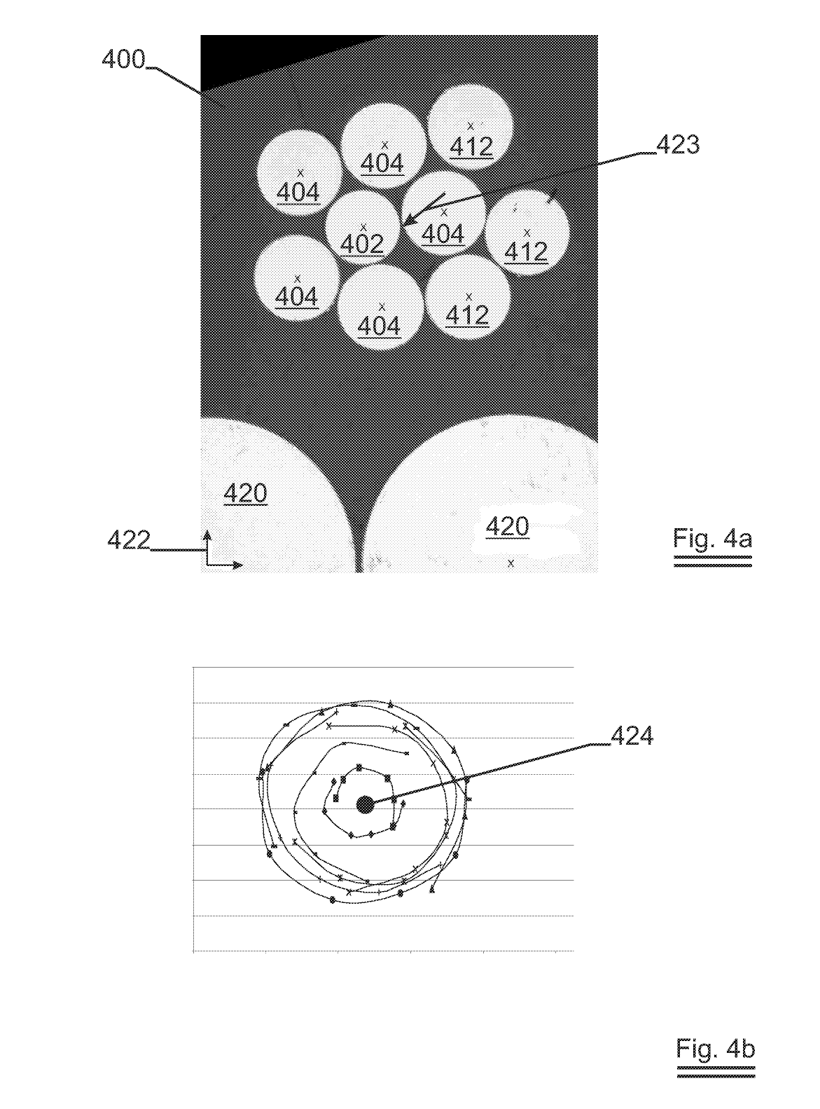

The aggregate gap for this configuration is 45.0% of 0.20. The d₁/d₀ ratio is 1.14. FIG. 4 ‘a’ shows a cross section 400 of the cord on which the core filament 402, the first layer filaments 404 and the second layer filaments 412 can be clearly discerned. Such cross sections are made by fixing a cord in a hard polymer casting, cutting the sample through and polishing it. By gradually polishing away layer by layer, a sequence of cross sections can be made out of which the traces of the filament centres—indicated by ‘x’ in the drawing—can be reproduced. By introducing two parallel wires 420 in the casting a reference frame 422 can be constructed relative to which the position of the filament centres can be measured. In FIG. 4 ‘b’ the construction of the orbit followed by the different filaments is shown based on 6 of said cross sections at 0.0, 1.34, 2.68, 4.09, 5.45, 6.98 mm i.e. over about half a lay length. The trace of the core filament 402 is represented by the diamond ‘♦’, the lines connecting the symbols are only for guidance of the eye. Clearly the core filament is not straight and shows a helical deformation. Based on such a cross section, also a ‘centre of gravity’ can be defined indicated by the arrow 423 in FIG. 4 ‘a’. This ‘centre of gravity’ does not move much relative to the frame 422 as indicated by the hatched region 424 in FIG. 4 ‘b’.

1. A steel cord for reinforcing elastomer goods, comprising a core filament with a core filament diameter, a first layer of filaments disposed around said core filament said first layer filaments having diameters larger or equal to said core filament diameter, and a second layer of filaments disposed around said first layer, said second layer filaments having diameters larger or equal to said core filament diameter, all said filaments being twisted together with the same lay length and direction
wherein said lay length, said core filament diameter and said first layer filament diameter are such that an aggregate gap between first layer filaments of at least 40% and at most 70% of said core filament diameter can form in which intermittently a filament of said second layer is nested such that said core filament is substantially helically deformed with said lay length and direction.

2. The steel cord according to claim 1, wherein said first layer comprises filaments with a first filament diameter, said first filament diameter being larger than said core filament diameter.

3. The steel cord according to claim 2, wherein said first layer comprises filaments with a core filament diameter next to said filaments with said first filament diameter.

4. The steel cord according to claim 3, wherein said first layer consists of filaments with a core filament diameter next to said filaments with said first filament diameter

5. The steel cord according to claim 1, wherein the number of filaments in said first layer is three, four or five.

6. The steel cord according to claim 5, wherein the number of filaments in said first layer is five and the ratio between the first layer diameter and the core filament diameter is between 102% and 120%.

7. The steel cord according to claim 6, wherein the number of filaments in said second layer is from one to ten.

8. The steel cord according to claim 7, wherein said second layer filaments either have a core filament diameter or a first filament diameter.

9. The steel cord according to claim 7, wherein said second layer filaments all have a first filament diameter.

10. The steel cord according to claim 5, wherein the number of filaments in said first layer is four and the ratio between the first filament diameter and the core filament diameter is between 170% and 205%.

11. The steel cord according to claim 10, wherein the number of filaments in said second layer is from two to eight.

12. The steel cord according to claim 11, wherein said second layer filaments either have said core filament diameter or said first filament diameter.

13. The steel cord according to claim 11, wherein said second layer filaments all have said first filament diameter.

14. The steel cord according to claim 1, wherein said filaments are brass coated.

15. The steel cord according to claim 1, wherein said filaments are zinc coated.

16. The steel cord according to claim 15, wherein the zinc coating is thinner than two micrometer and is applied through a hot dip galvanising process.

17. The steel cord according to claim 14, wherein said filaments are coated with an adhesive primer comprising at least one out of the group of organofunctional silanes, organofunctional titanates, or organofuctional zirconates.

18. A method to produce a steel cord comprising the steps of
providing a core filament on a spool;
providing first layer filaments and second layer filaments on spools, said filament having diameters in said first and second layer selected according to claim 1;
providing an assembly machine having an axis of rotation for twisting said filaments together with a lay length and direction;
feeding said filaments from said spools into said assembly machine wherein said core filament is entered centrally to said first layer filaments in a first cabling point thus forming an intermediate strand, the remaining filaments being disposed around said intermediate strand in a further cabling point
wherein said core filament enters said first cabling point under a stationary angle with said rotation axis of said assembly machine.

19. The method according to claim 18, wherein said first layer filaments are fed angularly one-sided to said core filament such that said first layer filaments form an aggregate gap in which a filament of said second layer intermittently nests.

20. The method according to claim 18, wherein said filaments are fed into said assembly machine with a pay-off tension, said pay-off tension of said core filament being less than any one of the pay-off tensions of said first and second layer so as to provoke intermittent changeovers in filament position.

21. A reinforced elastomer product chosen from the group consisting of tyres, hoses, hoisting belts, conveyor belts, drive belts and reinforcing strips comprising said steel cord as claimed in claim 1.

22. The reinforced elastomer products according to claim 21, wherein said elastomer is polyurethane.

23. The reinforced elastomer products according to claim 21, wherein said elastomer is rubber.
